(19) United States
(12) Patent Application Publication
(10) Pub. No.: US 2007/0124702 A1
(43) Pub. Date: May 31, 2007

(54) Method and apparatus for entering desired operational information to devices with the use of human motions

(75) Inventor: Kazuhiko Morisaki, Kanagawa-ken (JP)

Correspondence Address: Christopher W. Brody;CLARK & BRODY, Suite 250, 1090 Vermont Avenue, N.W., Washington, DC, 20005, US

(73) Assignee: Victor Company of Japan, Ltd., Kanagawa-ken (JP)

(21) Appl. No.: 11/604,270

(22) Filed: Nov. 27, 2006

(30) Foreign Application Priority Data
Nov. 25, 2005 (JP) 2005-339746
Sep. 8, 2006 (JP) 2006-243652

(51) Int. Cl. G06F 3/00

(52) U.S. Cl. 715/863

(57) ABSTRACT

An apparatus is provided to enter operational information to an objective device based on a motion of an operator's hand. In the apparatus, an imaging device acquires image data of the operator's hand and an extracting unit extracts characteristic points of the motion of the hand in a spatial coordinate system of the image data by applying processing to the image data. A detecting unit detects, as extreme-value information, extreme-value points appearing in spatial coordinates of the characteristic points and detection time instants at which the extreme-value points appear. A memory device is used to memorize the extreme-value information. An orbit determining unit determines whether or not four or more consecutive pieces of the extreme-value information corresponding to desired operational information comply with a predetermined circular-orbit condition and an outputting unit outputs the desired operational information to the device depending on a result determined by the orbit determining unit.

### CROSS REFERENCE TO RELATED APPLICATIONS

Japanese Patent applications No. 2005-339746 filed on Nov. 25, 2005 and No. 2006-243652 filed on Sept. 8, 2006.

### BACKGROUND OF THE INVENTION

1. Field of the invention

The present invention relates to a method and apparatus for entering desired information to electronic devices through human actions, and in particular, to such a method and apparatus that realizes the entry with the use of human's hand actions.

2. Description of the Related Art

Conventionally, a variety of techniques for entering desired information to electronic devices, such as on-vehicle electronic devices and home electric appliances, have been known. Such techniques require an image sensor to detect the contour and actions of an operator's hand. The actions are previously assigned to predetermined operation signals used in such devices, so that the devices receive the detected signals to interpret an operation signal expressed by the actions. These techniques eliminate the need for operator's handling of dials, switches, touch panels, and remote controls, while still allowing the contour and actions of an operator's band to give commands to electronic devises. Thus, for example, an on-vehicle devise can be controlled by using this entry device, with a driver's view point still kept forward. In the home electric appliances, although an operator is not needed to move to the operation panel on an appliance or use a remote control, the appliance can be controlled by remote control.

Several known techniques describing the above remote control can be listed as below.

Japanese Patent Laid-open Publication No. 11-338614 discloses an apparatus in which imaging means acquires images to make a comparison between operator's actions and predetermined action patterns. When there is a match between the actions and the patterns, an operation signal corresponding to a matched pattern (detected action) is outputted from the apparatus. As one application, this publication describes a control system using this entering apparatus, in which a person who takes a shower performs various actions in front of imaging means so that, for example, the operations of the shower are controlled at person's will.

Japanese Patent Laid-open Publication No. 2001-216069 discloses an entering apparatus that uses two types of gestures detected by detecting means. One type of gestures is a shape gesture defined as a gesture by the contour of a hand and the other type of gestures is a directional gesture defined by directions along which the hand is moved. These two types of gestures are detected by detecting means, in which one type of gestures is assigned to selecting operation modes and the other type of gestures is assigned to changing parameters of the selected operation mode. According to the present publication, the present entering apparatus is applicable to for example an on-vehicle audio system and an on-vehicle air conditioner. Japanese Patent Laid-open Publication No. 2005-47331 proposes a similar system to the publication No. 2001-216069.

In addition, Japanese Patent Laid-open Publication No. 11-327753 discloses an entering system which employs an imaging device to recognize actions or attitudes of a plurality of operators. The recognized results are used to remote-control devices.

In the foregoing various entering apparatuses or systems, the imaging device or detecting means are described as being particular sensors, such as image sensors composed of a C-MOS array with less pixels or a CCD array and an infrared-ray sensor array to detect the temperature of a dimensional detected area. In addition, the foregoing publications also propose, as the imaging device or detecting means, use of high-resolution images obtained from CCD cameras such that the Images are subjected to analysis to detect the contour and actions of an operator's hand.

However, the foregoing entering apparatuses and systems have still confronted various difficulties.

The foregoing publications detail the basic configuration of each entering apparatus and the relationship between the contour and actions of an operator's hand and controlled patterns of an objective device. However, these publications fail to explicitly detail an analysis algorithm to detect and recognize the actions of an operator's hand. In particular, no practical technique for detecting circular actions of the hand is given. In terms of operational feelings, the hand circular motion is easier to be made to correspond to operations at a dial on an electronic device. And the rotational directions can express dial up/down directions. For those reasons, it is easier to employ the circular motion as operator's actions for various types of control of a device. Even though there are those circumstances, the foregoing publications are silent about practical ways to detect the circular motions.

For example, the first publication No. 11-338614 provides no practical explanation about the detection and recognition of hand motions, though the circular motion of an operator's hand is explained as an example of operational motions. In addition, the second publication No. 2001-216069 does not refer to the circular motion, although there is an explanation for the correspondence between the upward, downward, leftward and rightward linear motions as the directional gestures and items to be controlled. The same is true of the third publication No. 2005-47331, in which the technique for detecting and recognizing the hand motions is entirely focused on the general. Further, the control way disclosed in publication No. 11-327753 is also focused on the general explanation and is far from being practical.

### SUMMARY OF THE INVENTION

The present invention has been made in consideration of the foregoing difficulties, and an object of the present invention is to provide an apparatus and method for, in an accurate and reliable manner, recognizing operator's hand motions in images acquired by an imaging device and providing an electronic device with operational information corresponding to the motions.

In order to realize the above object, as one aspect, the present invention provides an apparatus for entering operational information to an objective device based on a motion of an operator's hand. In the apparatus, an imaging device acquires image data of the operator's hand and an extracting unit extracts characteristic points of the motion of the hand in a spatial coordinate system of the image data by applying processing to the image data. A detecting unit detects, as extreme-value information, extreme-value points appearing in spatial coordinates of the characteristic points and detection time instants at which the extreme-value points appear. A memory device is used to memorize the extreme-value information. An orbit determining unit determines whether or not four or more consecutive pieces of the extreme-value information corresponding to desired operational information comply with a predetermined circular-orbit condition and an outputting unit outputs the desired operational information to the device depending on a result determined by the orbit determining unit.

As another aspect, the present invention provides apparatus for entering operational information to an objective device based on a motion of an operator's hand; imaging means for acquiring image data of the operator's hand; extracting means for extracting characteristic points of the motion of the hand in a spatial coordinate system of the image data by applying processing to the image data; detecting means for detecting, as extreme-value information, extreme-value points appearing in spatial coordinates of the characteristic points and detection time instants at which the extreme-value points appear; memory means in which the extreme-value information is memorized; orbit determining means for determining whether or not four or more consecutive pieces of the extreme-value information corresponding to desired operational information comply with a predetermined circular-orbit condition; and outputting means for outputting the desired operational information to the device depending on a result determined by the orbit determining means.

In the present invention, a circular orbit motion of an operator's hand is processed as a typical motion to express an operator's will for operations. Hence such circular orbit motions of the hand are detected from image data acquired by the imaging device. The detected circular orbits are then subjected to determination whether or not the detected circulars orbit truly correspond to operational information previously assigned to a particular circular orbit motion. If the determination is positive, the determined operation information is inputted to an electronic device as an operator's operational will. To be specific, the processing for detecting a motion of the hand is first applied to the acquired image data, in which the motion is detected between image data frames to extract characteristic points. The movement of the characteristic points is detected as changes of the spatial coordinates. If the motion depicts a circular orbit, the changes of the spatial coordinates provide appearances of four or more times extreme values during one turn of the orbit. Thus, whenever an extreme value is detected, the spatial coordinate of a characteristic point and a detection time instant, which are obtained at the detection timing, are memorized as information indicative of extreme values (hereinafter referred to as “extreme-value indicating information”). The memorized extreme-value indicating information provides a time-series positional relationship, so that it is determined whether or not this positional relationship is adapted to a circular orbit pattern. If the adaptation is admitted, operational information assigned to the circular motion of the hand Is inputted to the device.

### BRIEF DESCRIPTIONS OF THE DRAWINGS

In the accompanying drawings:

FIG. 1 is a block diagram showing the configuration of a TV receiver with a camera (with a TV phone function), in which a first embodiment of an operational-information entering apparatus according to the present invention is reduced into practice as to sound volume control of the apparatus;

FIG. 2 is a block diagram showing a part responsible for controlling sound volume in an operational-information processor arranged in the entering apparatus;

FIG. 3 is a flowchart explaining the processing for extracting characteristic points from images;

FIG. 4 is a flowchart explaining the processing for detecting extreme values appearing in a set of extreme values;

FIG. 5 is a flowchart explaining the processing for determining the conformity of a determined circular orbit with a predetermined (reference) circular orbit and for outputting a gain control signal;

FIG. 6 illustrates the extreme-value points appearing in the characteristic points and their spatial coordinates and conditions under which such spatial coordinates conform with the predetermined circular orbit;

FIG. 7 is a timing chart explaining the extreme-value positions appearing in each of two circular orbits with a long interval therebetween;

FIG. 8 is a timing chart explaining the extreme-value positions appearing in each of two circular orbits with no interval therebetween;

FIG. 9 is a timing chart explaining the extreme-value positions appearing in each of two circular orbits with a short interval therebetween;

FIG. 10 is a block diagram showing the configuration of a TV receiver with a camera (with a TV phone function), in which a second embodiment of an operational-information entering apparatus according to the present invention is reduced into practice as to sound volume control and channel selection of the apparatus;

FIG. 11 is a block diagram showing a part responsible for controlling sound volume and for selecting channels in an operational-information processor arranged in the entering apparatus;

FIG. 12 is a flowchart detailing the processing for selecting the channels;

FIG. 13 is a timing chart explaining a first condition adopted in the second embodiment, the first condition relating to a time difference between circular orbits C(i−1) and C(i) being determined;

FIG. 14 illustrates the sizes of the two circular orbits C(i−1) and C(i) and a relational relationship between the two circular orbits C(i−1) and C(i);

FIG. 15 illustrates two operators who are in front of a CCD camera to move their hands along circular orbits, these operations relating to a third embodiment of the present invention;

FIG. 16 is a partial block diagram showing parts responsible for image data reception to selection of a circular orbit in an operational-information processor according to the third embodiment of the entering apparatus;

FIG. 17 is a flowchart showing the processing for extracting characteristic points in the third embodiment;

FIGS. 18A, 18B and 18c illustrate some steps in the processing of extraction of the characteristic points;

FIG. 19 is a flowchart explaining the processing for detecting extreme values appearing in a set of extreme values;

FIG. 20 is a flowchart explaining the processing for determining a circular orbit;

FIG. 21 is a flowchart explaining the processing for selecting a circular orbit through comparison made between the radii of circular orbits; and

FIG. 22 is a flowchart explaining the processing for selecting a circular orbit through comparison made between the rotational speeds of circular orbits.

### DETAILED DESCRIPTION OF PREFERRED EMBODIMENTS

Referring to accompanying drawings, various embodiments of an operational-information entering apparatus according to the present invention will now be described.

### First Embodiment

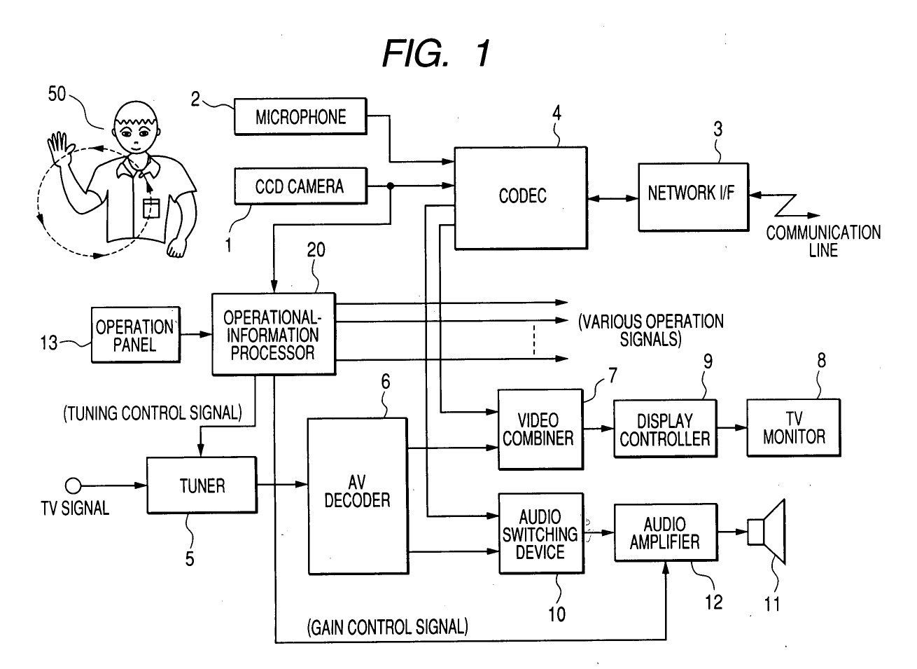

Referring to FIGS. 1-9, a first embodiment of the operational-information entering apparatus will now be described.

FIG. 1 shows in block form the configuration of a TV (television) receiver with a camera having a video phone function. The TV receiver is provided with a CCD camera 1 that is able to image an operator (a person who uses the phone) and a microphone 2 collecting sound. This TV receiver is also provided with a network I/F 3 that transmits and receive packets of video and audio data via a communication line in a TV phone mode, in addition to various other components, such as a codec 4, a tuner 5, an AV decoder 6, a video combiner 7, a TV monitor 8, a display controller 9, a video switching device 10, speakers 11, an audio amplifier 12, an operation panel 13, and an operational-information processor 20.

Of these components, the codec 4 is configured to, in the TV phone mode, not only code video and sound signals acquired from the CCD camera 1 and microphone 2 to output the coded signals to the network I/F 3 as packet data but also decode the packet data received through the network I/F 3 into video and audio signals to provide the video combiner 7 with the decoded signals. The tuner 5 tunes a selected channel in the TV function. The AV decoder 6 is a decoder to decode TV signals in a selected channel. The video combiner 7 is a component to produce signals to be displayed in which TV signals from the AV decoder 6 are overlaid on video signals from the codec 4.

Further, the display controller 9 is formed to make signals being displayed, which are produced by the video combiner 7, on the TV monitor 8. The audio switching device 10 performs switchovers between the audio signals from the AV decoder 6 and the audio signals from the codec 4, so that the audio signals from either one is outputted. When receiving the audio signals from the audio switching device 10, the audio amplifier 12 amplifies the received audio signals in response to a gain control signal and outputs the amplified audio signals to the speakers 11.

Using the above components, the present TV receiver is given a TV function to which a TV phone function is added. The former function is mainly realized by the tuner 5, AV decoder 6, video combiner 7, TV monitor 8, display controller 9, audio switching device 10, speakers 11 and audio amplifier 12. The latter function is realized by the CCD camera 1, microphone 2, network I/F 3, and codec 4.

Further, the present TV receiver is characteristic of having the operational-information processor 20 that provides user's operational information to the parts realizing the TV function and the TV phone function through an operator's (user's) direct operation at the operation panel 13 as well as an operator's action performed in front of the CCD camera 5. That is, the operational-information processor 20 responds to operator's manual operations at various buttons of the operation panel 13, so that the processor 20 outputs control signals in compliance with the button operations. Such control signals control both states of the TV function and the TV phone function. In addition, the operational-information processor 20 is also responsible for adjusting sound volume in a remote control manner. An operator (user), who is in front of the CCD camera 1 and faces almost directly thereto, moves his or her hand along a circular orbit in the air. The operational-information processor 20 receives image data from the CCD camera 1 and, based on the received image data, answers such motions of the operator's hand to control the sound volume. Concretely, the processor 20 first analyzes image data from the CCD camera 1 to determine whether or not the operator's hand motion is along a predetermined circular orbit and reflects the determined results in a gain control signal to the audio amplifier 12.

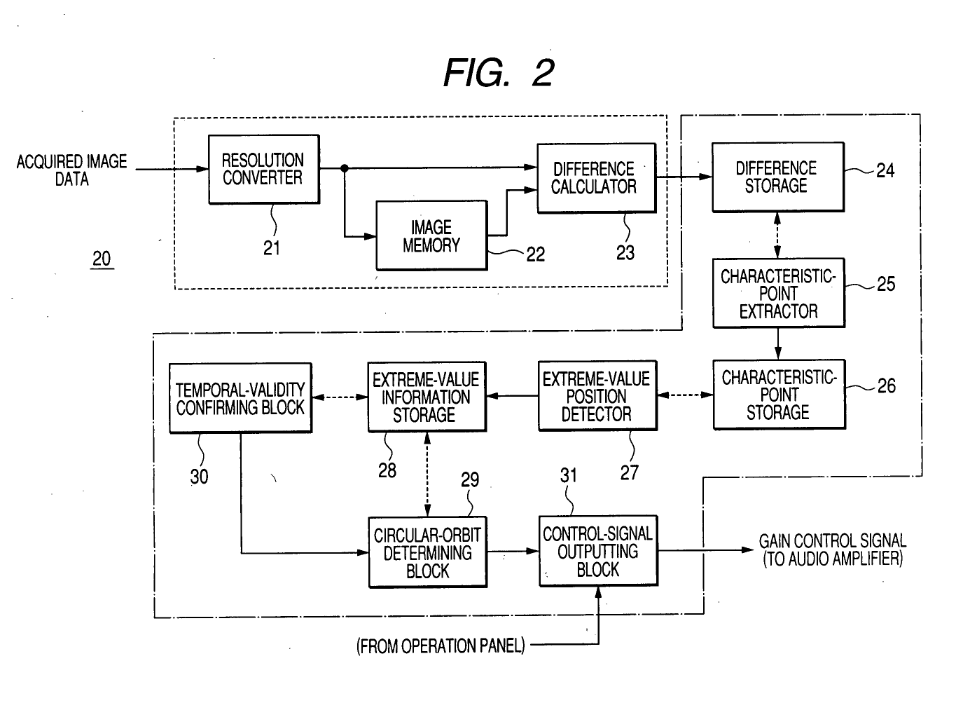

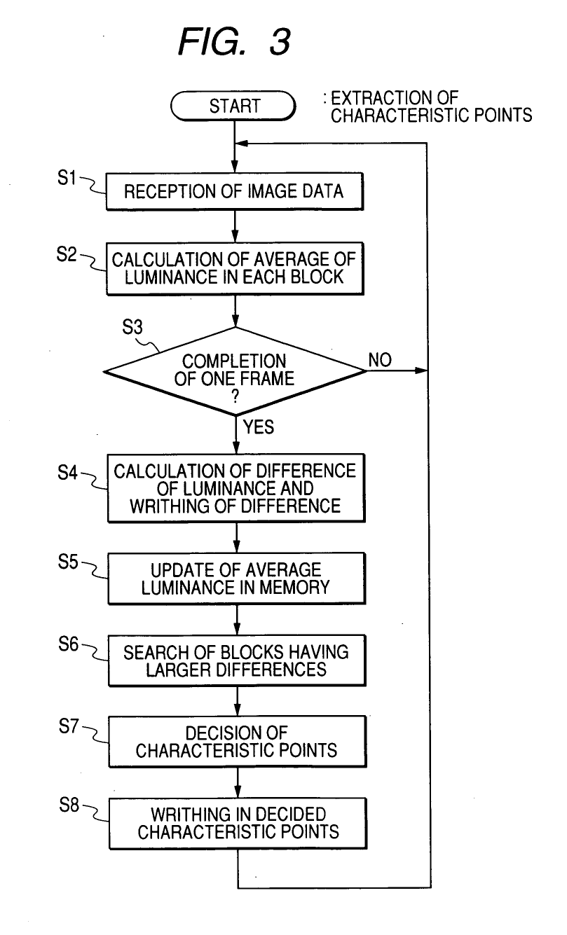

As shown in FIG. 2, the processor 20 functionally has a configuration for adjusting the sound volume, which includes an analysis of the acquired image data. FIG. 3 shows a flowchart of processing carried out by the components of the processor 20, wherein the flowchart explains a series of procedures for extracting characteristic points showing the motions of an operator's hand from image data for storage thereof.

The processor 20 functionally comprises, as shown in FIG. 2, a resolution converter 21, an image memory 22, a difference calculator 23, a difference storage 24, a characteristic-point extractor 25, a characteristic-point storage 26, an extreme-value position detector 27, an extreme-value information storage 28, a temporal-validity confirming block 30, a circular-orbit determining block 29, and a control-signal outputting block 31.

In the processor 20, image data acquired by the CCD camera 1 is sent to a resolution converter 21, where the image data is converted to image data of a minimum resolution necessary for detecting the operator's hand motion (steps S1 and S2). For instance, for the TV monitor 8 composed by a monitor with a large-sized screen made of plasma or liquid crystal, the CCD camera 1 produces VGA image data of 640×480 pixels at a transfer rate of 30 frames per second. When the TV monitor is relatively small in size, which is for example 14-inch screen, the CCD camera 1 produces QVGA image data of 320×240 pixels at a transfer rate of 30 frames per second. The resolution converter 21 calculates an average of luminance (absolute value) over 64 pixels of each block (8×8 pixels) sectioned in each frame. The luminance average is treated as luminance data of each block. Accordingly, the resolution converter 21 converts the QVGA image data to luminance data of 8 bits in each of each of the 40×30 blocks, and such converted luminance data is outputted frame by frame. Incidentally, for detecting operator's hand motions, it is sufficient to obtain the luminance information. Thus chrominance information is disposed of in the resolution converter 21.

The image data by the resolution converter 21 is given, frame by frame, to an image memory 21 and a difference calculator 23. The image memory 22 acts as a buffer memory. The difference calculator 23 calculates, block by block, differences between the luminance averages of the current-frame image data and the luminance averages of the immediately-before-frame image data stored in the image memory 22, and writes the difference data into the difference storage 24 (steps S3 and S4). And the luminance averages of the respective blocks of the immediately-before-frame image data are updated to those of the current-fame imaged data in the image memory 22 for the next difference calculation (step S5).

In response to writing the difference data of each frame into the difference storage 24 at step S4, the characteristic-point extractor 25 works such that the extractor 25 searches the blocks for blocks that have difference data whose values falls into the top four amounts and calculates averages of spatial coordinates (X- and Y-coordinates) of each of the blocks that have been searched. Hence the averaged coordinates, i.e., the central point, of each of the selected four blocks are figured out as a characteristic point showing larger differences (steps S6 and S7). Hence, as illustrated in FIG. 1, when the operator 50 moves his or her hand (and arm) in front of the CCD camera 1, some blocks tracing the motions of the hand show larger difference data. The central point (X- and Y-coordinates) at each of those blocks is obtained as a characteristic point.

The spatial coordinates of the respective characteristic points, which are provided by the extractor 25, are written into the characteristic-point storage 26. The foregoing steps S1 to S8 are repeated whenever image data of each frame acquired by the CCD camera 1 are provided.

The characteristic-point storage 26 is formed as a ring buffer type of storage for 2 seconds, so that the spatial coordinates of the obtained characteristic points for 2 seconds are sequentially written into this storage 26, with the written data constantly updated to the newest data obtained for the last 2 seconds. The reason why the period of 2 seconds is adopted is that the rotation speed of a person's hand in the air is usually 1.5 to 3 times per two seconds, although such a speed differs person by person. If 2 seconds are given for the measurement, at least one rotation of the hand can be detected in most cases. Incidentally, if it is assumed that each of the X- and Y-coordinates in the spatial coordinate is expressed as data of one byte, the capacity necessary for the storage 26 is as less as 120 bytes (=2 bytes×30 frames×2 seconds).

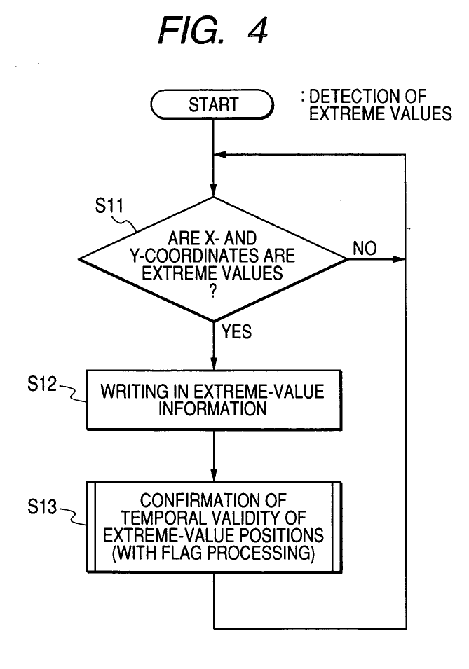

Then the processing in the processor 20 is shifted to the extreme-value position detector 27 and the temporal-validity confirming block 30. The operations of those members 27 and 30 will now be described with reference to FIG. 4.

The characteristic points written in the characteristic-point storage 26 are then subjected to detection of extreme points carried out by the extreme-value position detector 27. Further, each extreme position is also subjected to confirmation of its temporal validity carried out by the temporal-validity confirming block 30.

The extreme-value position detector 27 applies the hill-climb search technique to the X- and Y-coordinates of each characteristic point to check whether or not the point is an extreme value. When either one of the X- and Y-coordinates shows an extreme value, data indicative of a spatial coordinate and a detection time instant, both are decided in response to finding the extreme value, is written into the extreme-value information storage 28. This storage 28 also operates on a ring buffer scheme, in which the data indicative of the spatial coordinate and the detection time instant of each extreme-value position are stored in sequence with the data constantly updated to the newest data obtained for the last 2 seconds (steps S11 and S12 in FIG. 4).

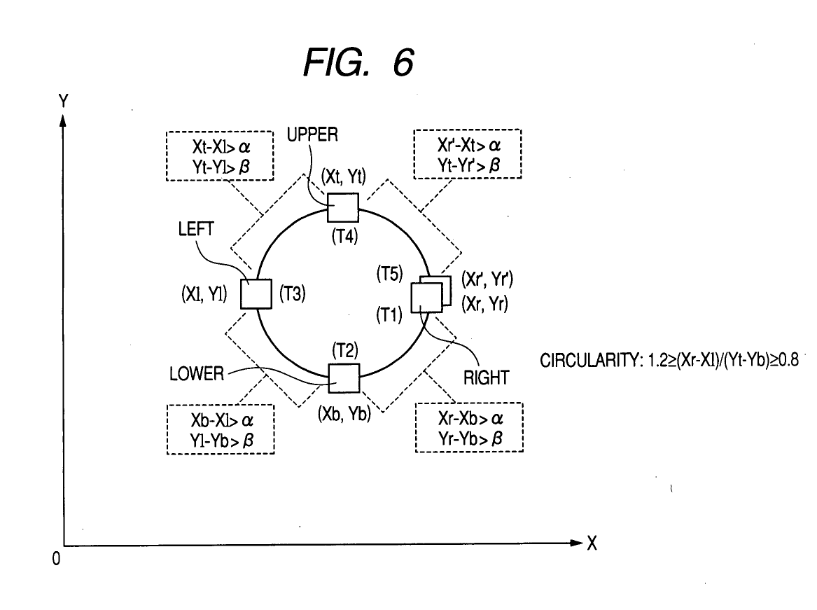

Practically, in a case where the hand of the operator 50 who is almost in front of the CCD camera 1 is moved to trace a circular orbit in the air, the characteristic positions have spatial coordinates shown in FIG. 6, where the X- and Y-coordinates provide extreme values by turns at respective positions denoted as “right,” “down,” “left,” and “up.” That is, in the coordinate shown FIG. 6, Xr and Xr′ are extreme values at the position “right,” Yb is an extreme value at the position “down,” X1 is an extreme value at the position “left,” and Yt is an extreme value at the position “upper.” Data indicating the spatial coordinates of those extreme positions are stored into the storage 28, together with the detection time instants at which those extreme positions are found. The rotational direction of the extreme positions appearing in turns in the spatial coordinate system shown in FIG. 6 is based on a rotational direction imaged in the images acquired from the CCD camera 1, which is opposite to the actual rotational direction of the hand.

The temporal-validity confirming block 30 has a function for confirming the temporal validity of each extreme position in consideration of an actual rotational speed of the operator's hand. This confirming function allows each extreme position to be confirmed as being “valid” or “invalid” on either the following two criteria and the confirmed results are expressed by flags (step S13).

Criterion (1): As stated, the operator's hand rotating at a speed of 1.5 to 3 times per two seconds results in a period of time of 0.66-1.33 seconds per rotation (i.e., 20-40 frames). Thus, if, in the storage 28, a temporal difference ΔTa between the detection time instant at which the latest extreme position is found and the detection time instant at which an extreme position acquired before the latest one by “4 positions” is largely deviated from 0.66-1.33 seconds, all the spatial coordinates existing within the time period of ΔTa are doubtful as to whether those coordinates truly indicate the extreme positions or not. For confirming such a doubtful situation, the determinations on ΔTa≦0.3 seconds and ΔTa≧3 seconds are conducted, for instance. Hence if a situation satisfying ΔTa≦0.3 seconds or ΔTa≧3 seconds is found, a flag (called Dirty flag) assigned to the spatial coordinates is made ON for disabling those data.

Criterion (2): When there are four extreme positions, a period of time between adjacent detection time instants each providing an extreme position is approximately 0.16-0.33 seconds (5-10 frames). Therefore, if a time difference ΔTb between detection time instants providing consecutive extreme positions is largely deviated from 0.16-0.33 seconds, all the spatial coordinates existing after this pair of detection time instants are also doubtful as to whether those coordinates truly indicate the extreme positions or not. For confirming such another doubtful situation, the determinations on ΔTb≦0.05 seconds and ΔTb≧1 second are conducted, for instance. Hence if a situation satisfying ΔTb≦0.05 seconds or ΔTb≧1 second is found, the Dirty flag assigned to the spatial coordinates is made ON for disabling those data.

As a result, the determinations on the foregoing criteria make it possible that only the extreme positions satisfying a predetermined temporal condition are left and validated. By this validation, it is possible to check whether or not the operator 50 really intends to adjust the sound volume by rotating his or her hand along a circular orbit. That is, the hand motions other than the validated ones are regarded as. being erroneous operations to the processor 20, and prevented from inputted.

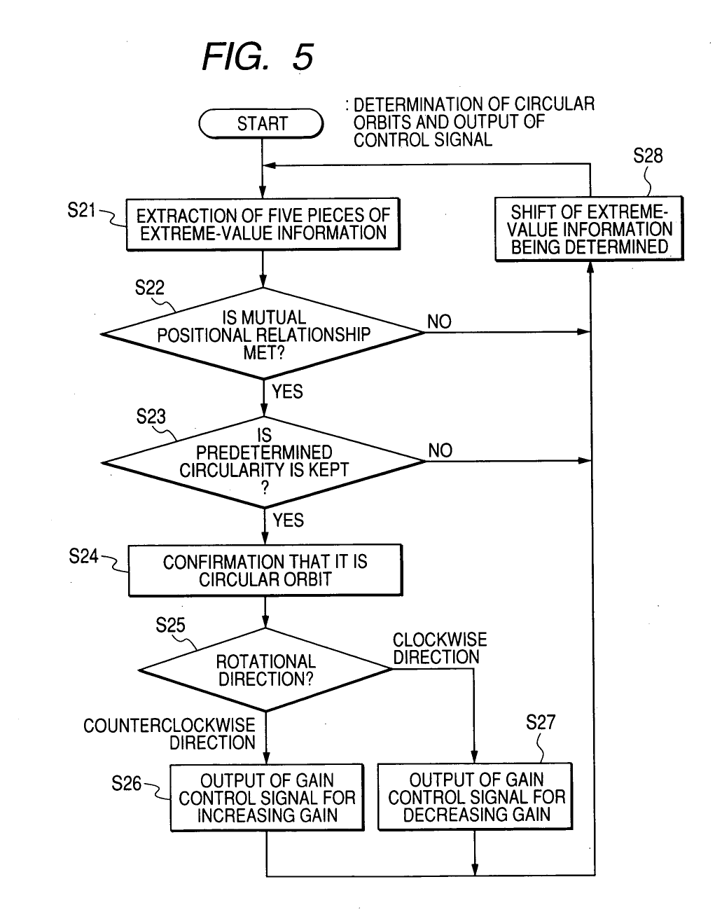

Then the circular-orbit determining block 29 operates as shown in FIG. 5. This block 29 uses the information about extreme positions stored in the extreme-value information storage 28 to determine if or not each extreme-value position complies with any of predetermined circular orbits including perfect circular orbits and elliptic orbits and to calculate the rotational direction of the circular orbit along which the extreme positions are tracked. The above information consists of data showing the spatial coordinates of the respective extreme-value positions and the detection time instants. These determined and calculated results are reflected in a gain control signal being outputted.

Specifically, the circular-orbit determining block 29 first extracts time-serial and consecutive five pieces of extreme-value information that have been validated by the temporal-validity confirming block 30 (i.e., the Dirty flag is OFF) (step S21). By the way, the number of pieces of extreme-value information used for determining the circularity of circular orbits may be at least four or more than five.

This block 29 further determines whether or not the extracted extreme-value information meets the following two checking conditions, whereby the determination whether or not the extreme-value information is adapted to the circular orbit (steps S22 and S23).

Condition (1): A first condition is whether or not the time-serial and continuous five spatial coordinates have a mutual positional relationship necessary for realizing a circular orbit. For example, if an assumption is made such that a clockwise circular orbit starts from a right upper position in the imaged screen, the coordinates showing the extreme positions can be set as shown in FIG. 6, in which there are provided a “right” coordinate (start position) of (Xr, Yr), a “lower” coordinate of (Xb, Yb), a “left” coordinate of (XI, YI), an “upper” coordinate of (Xt, Yt), and a “right” coordinate (end position) of (Xr′, Yr′). Thus, if the conditional expressions consisting of

“Xr−Xb>αand Yr−Yb>β” between the “right (start position” and “lower” coordinates;

“Xb−XI>αand Yb−YI>β” between the “lower” and “left” coordinates;

“Xt−XI>αand Yt−YI>β” between the “left” and “upper” coordinates; and

“Xr′−Xt>αand Yr′−Yt>β” between the “upper” and “right (end position” coordinates

are all satisfied, the mutual positional relationship is regarded as being met. In these conditional expressions, the constants α and β are variable weighting factors which are set depending on the radius of a circular orbit depicted in images being acquired. For example, when a person moves his or her hand along a circular orbit with the person's simplest action, the orbit has usually a radius of some 20-50 cm. The constants α and β are set to amounts corresponding to such a radius in the images.

Condition (2): A second condition is whether or not a circular orbit estimated from the time-serial and continuous five spatial coordinates has a circularity of a predetermined level or more. When exemplified in FIG. 6, a ratio between the distance between the “right” and “left” position coordinates and the distance between the “upper” and “lower” position coordinates is computed and the resultant ratio is determined as to whether or not the ratio falls into an allowable range including 1 (one). By way of example, a conditional expression of
1.2≧(Xrave−XI)/(Yt−Yb)≧0.8
is used for such a determination, in which Xrave is an average between Xr and Xr′, i.e., (Xr+Xr′)/2. If the spatial coordinates meet this expression, it is considered that the estimated circular orbit satisfies the circularity.

When the circular orbit having a predetermined circularity is found, the circular-orbit determining block 29 further proceeds to checking which way the circular orbit is rotated (steps S24 and S25). The rotation direction can be checked using the detection time instants at which the extreme-value positions are detected. The data of these time instants are already stored in the storage 28. For example, in the case of FIG. 6, the detection time instants given to the respective spatial coordinates are T1-T5 (T5>T4>T3>T2>T1). When considering this temporal relationship as well as a clockwise movement of the characteristic points in the images (from “right”, “lower”, “left”, “upper”, to “right” coordinates,” it can be found that the operator 50 has rotated his or her hand along the counterclockwise direction.

When completing the determinations for the conformity of the detected circular orbit and the rotational direction, the circular-orbit determining block 29 notifies the control-signal outputting block 31 of the determined rotational direction. Responsively to this, the outputting block 31 provides the audio amplifier 12 with a gain control signal in which the rotational direction is reflected (steps S25, S26 and S27).

Thereafter, the range of the extreme-value information being determined is shifted by 1 piece in the temporal ascending direction (step S28) and the foregoing processes at steps S21-S27 will be repeated. Hence, every time the block 29 determines not merely the circular orbit but also the rotational direction, the gain of the audio amplifier 12 is adjusted to increase or decrease depending on a direction along which the operator's hand is moved to trace the circular orbit. The adjusted gain is reflected in the output from the audio amplifier 12, and the sound volume from the speaker 12 is controlled by the gain control signal.

It is therefore possible for the operator 50 to control the sound volume from a distance by only rotating his or her hand along a circular orbit in the air. Thus the volume of sound in the phone mode and the TV mode can be remote-controlled by operator's hand actions, without using a remote control or operating the switches.

In the present embodiment, the counterclockwise and clockwise directions of circular orbits In the images (i.e., the clockwise and counterclockwise directions of operator's hand circular motions in the air) are assigned to the increase and decrease in the gain, respectively. This assignment of the directions gives operators the same operational feeling as that in adjusting the radio dial.

The relationship between the circular orbit and the sound volume control is not limited to the foregoing, but may be modified into further forms.

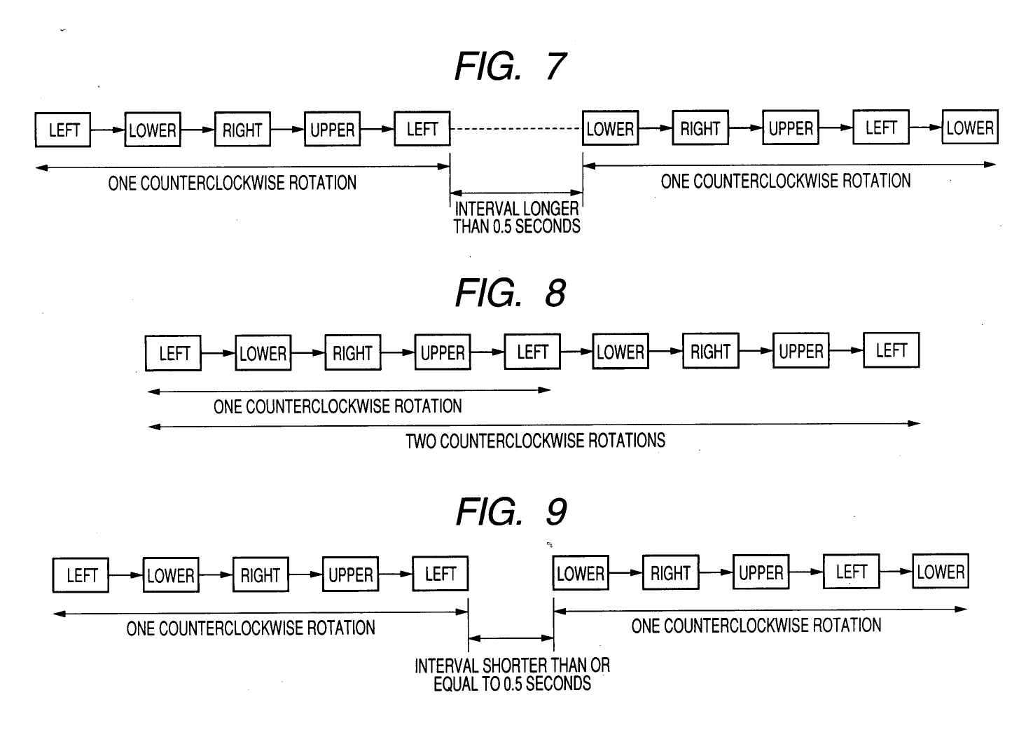

As illustrated in FIG. 7, it is possible to determine two-time counterclockwise rotations along a circular orbit, in which the first rotation is connected to the next one via a non-rotational interval of longer than 0.5 seconds. In this case, by way of example, such two-time rotations can be assigned to increasing the sound volume by two levels. Another modification is shown in FIG. 8, where two-time counterclockwise circular rotations with no rest between the rotations are detected. In FIG. 9, there is a further modification in which two-time counterclockwise circular rotations mutually connected via a non-rotational interval of 0.5 or less seconds. For example, the rotational schemes shown in FIGS. 8 and 9 can be assigned to a four-level increase in the sound volume. Influence of room lighting and/or instability of hand actions may make it difficult to determine plural continuous circular rotations. In such situations, it is effective to assign larger controlled amounts to a case in which the determination of circular rotation in the same direction is repeated plural times within a limited length of time.

Thus, it is possible to provide an apparatus and method for, in an accurate and reliable manner, recognizing operator's hand motions in images acquired by an imaging device and providing the receiver with operational information corresponding to the motions. In addition, the use of temporal-validity confirming block 30 strengthens the reliability of detection of operator's hand motions which are really intended to express a desired operation.

In the present embodiment and modifications, the operator's hand circular motions are used for remote-controlling the sound volume, but this is not a definitive list. Such hand motions may be connected to channel selection. In that case, the control-signal outputting block 31 is connected to the tuner 5 and configured to output to the tuner 5 a channel-selection control signal. This control signal is formed such that the determination of a counterclockwise circular rotation(s) is assigned to up-operation(s) in selecting the channels. For the determination of a clockwise circular rotation(s), the assignment is performed down-selecting the channels.

Further, the operational-information processor 20 can be made to provide the analysis function shown in FIG. 2 on signal processing using a specified hardware construction, such as analog/digital circuits, or on software processing using a DSP (Digital Signal Processor). Another configuration of the processor 20 is to employ a combination of hardware constructions and an MPU (Micro Processing Unit) or CPU (Central Processing Unit). In this configuration, preferably, the processing of the resolution converter 21, image memory 22, and difference calculator 23, which require the calculation on the pixel-by-pixel basis, are given by the hardware constructions, whilst the processing carried out by the members ranging from the difference storage 24 to the control-signal outputting block 31 is given by the MPU or CPU.

### Second Embodiment

Referring to FIGS. 10-14, a second embodiment of the operational-information entering apparatus will now be described. In the present embodiment and successive embodiments, the identical our similar components to those in the first embodiment will be given the same reference numerals for the sake of simplified explanations.

The second embodiment is characteristic of having the function of entitling operator's hand circular motions to command dual objective items being operated.

To put it briefly, although image data are subjected to analysis in the same way as that in the first embodiment in which it is determined whether or not operator's hand motions are along a circular orbit and the rotational direction is checked, the second embodiment additionally involves the determination of two successive circular rotations of an operator's hand. Of the two successive rotations that have been detected, the rotational directions of the former rotation are used as information to select a channel and to adjust the sound volume. The relative position of the later rotation to the former one is used as information for gain control in controlling the sound volume and/or information for selecting a channel.

In order to obtain such a function, a TV receiver with a camera according to the present embodiment adopts an operational-information processor 20A whose block form is the same as that shown in FIG. 1, except for members responsible for sound volume adjustment and channel selection on the basis of analyzed imaged data.

The whole block diagram of the operational-information processor 20A is outlined in FIG. 10. As shown, the processor 20A is additionally provided with a first confirming block 41, a circle information calculator 42, a circle information storage 43, a second confirming block 44, a pattern determining block 45, and a control-signal outputting block 46 arranged instead of the forgoing one 31.

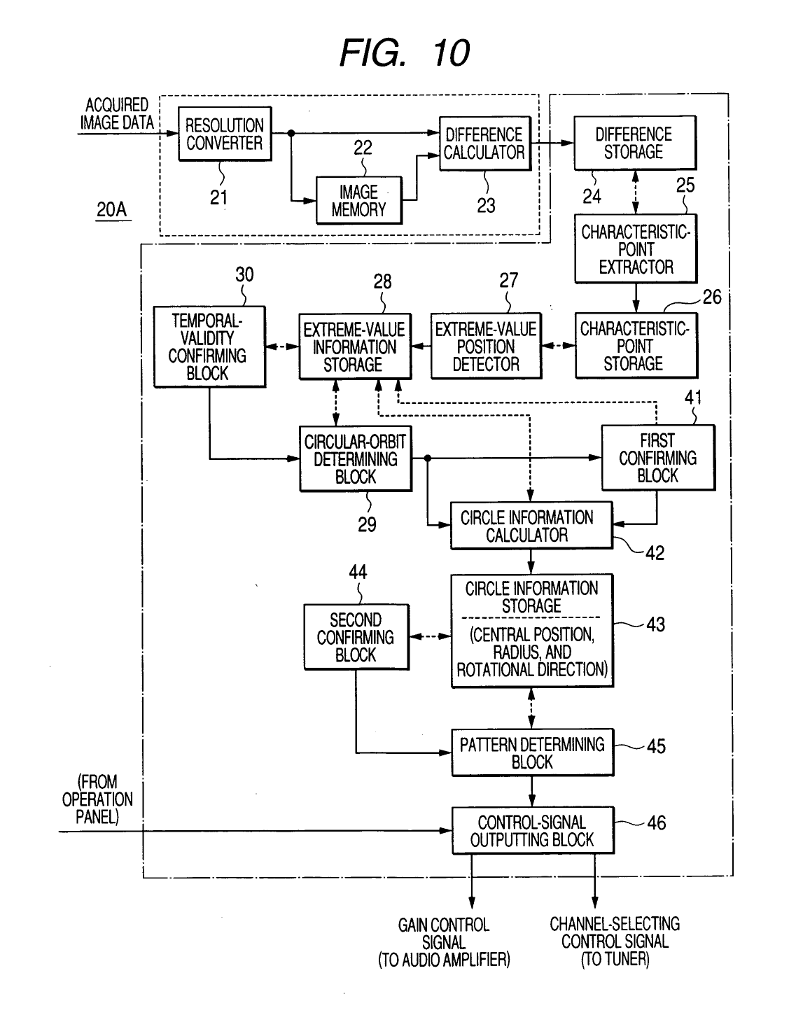

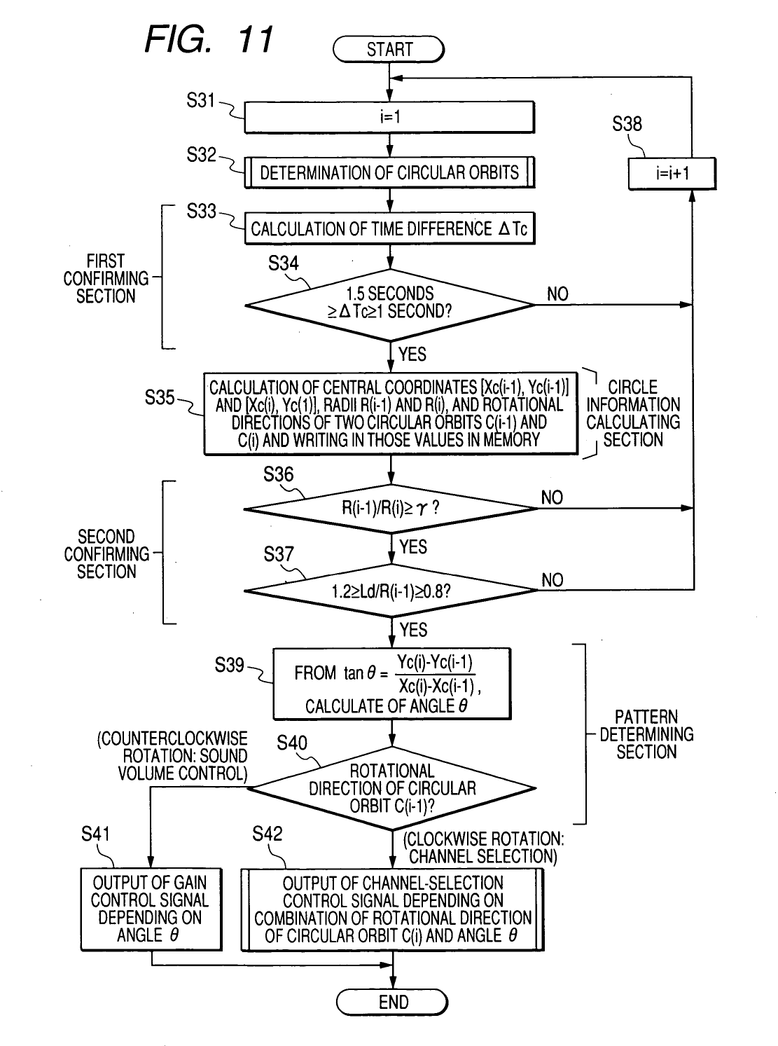

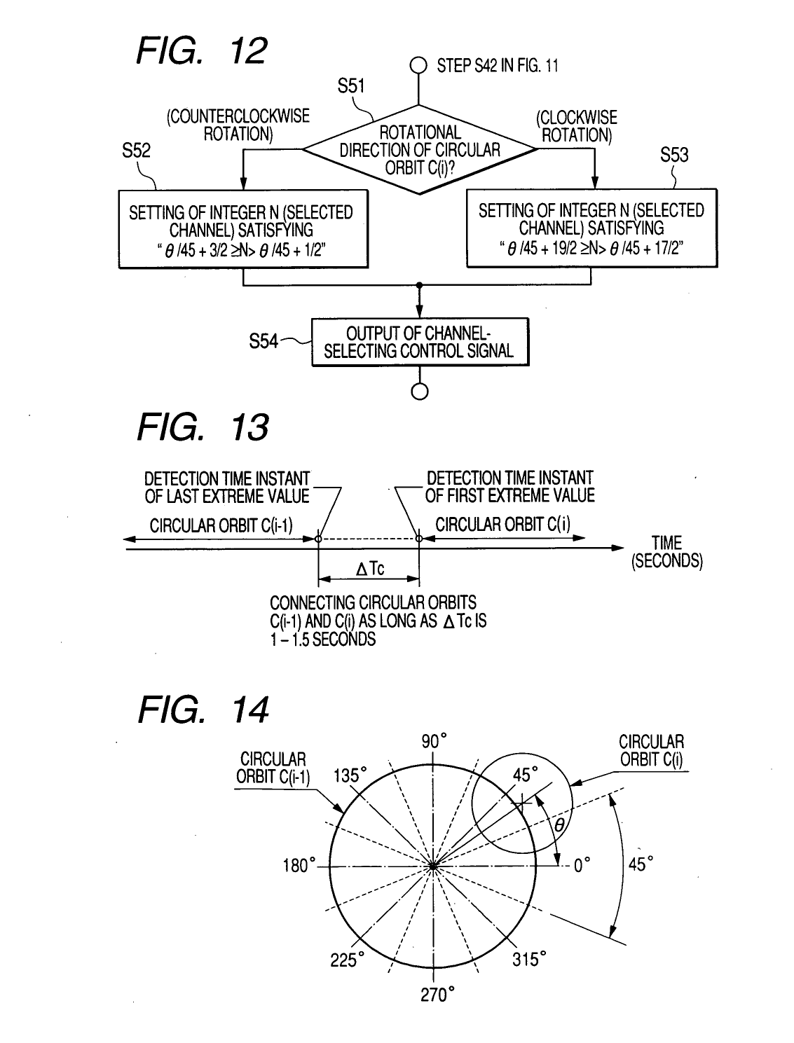

This processor 20A operates on the processes shown in FIG. 11. The processes from the analysis of image data to the determination of whether or not an operator's hand motion is along a circular orbit are identical to those in the first embodiment. That is, in the configuration in FIG. 10, by the functional members from the resolution converter 21 to the extreme-value position detector 27, characteristic points are extracted and their extreme values are detected. The extreme value information written in the extreme-value information storage 28 is subjected to the confirmation carried out by the temporal-validity confirming block 30, before being subjected, at the circular-orbit determining block 29, to the determination whether or not five time-series continuous extreme-value positions form a circular orbit (steps S31 and S32).

After the determination of the circular orbit at step S31 and S32, the first confirming block 41 uses the respective pieces of extreme value information In the storage 28 to compute a time difference ΔTc between a circular orbit C(i) determined this time (after-determined) and a circular orbit C(i−1) determined for the last time (before-determined). “i” is a parameter indicating the number of circular orbits being determined. And the block 41 determines whether or not the time difference ΔTc is within an allowable range of 1-1.5 seconds (steps S33 and S34). To be specific, as shown in FIG. 13, the time difference ΔTc between the last detection time instant during the determination of the circular orbit C(i−1) and the first detection time instant during the determination of the circular orbit C(i) is computed for the above confirmation. In the present embodiment, a first condition that requires the time difference ΔTc between the two temporally-adjacent circular orbits C(i−1) and C(i) should be within the allowable range is used for remote-controlling the TV receiver with the camera. These two circular orbits are depicted in the air by a hand of the same operator 50.

In cases where those two circular orbits C(i−1) and C(i) satisfy the first condition, the circle information calculator 42 uses the information about the respective extreme values stored in the storage 28 so that central coordinates [Xc(i−1), Yc(i−1)] and [Xc(i), Yc(i)], radii R(i−1) and R(i), and rotational directions of the respective circular orbits C(i−1) and C(i) are calculated and the resultant values are written into the circle information storage 43 (step S35). Then the second confirming block 44 confirms whether or not the two circular orbits C(i−1) and C(i) meet two items regulating the mutual relationship between those two circular orbits (steps S36 and S37). These two items which compose a second condition that should be paired with the foregoing first condition, are as follows.

Item (1): A first item, which is part of the second condition, is whether or not a relationship of
R(i−1)/R(i)>γ
is met. That Is, this item is confirm whether or not the before-determined circular orbit C(i−1) is larger in size the after-determined circular orbit C(i) and a rate between those two sizes is equal to or larger than a given value γ. The value γ may be set to an arbitrary amount, but preferably to 2 to 4.

Item (2): A second item, which is the remaining of the second condition, is whether or not a relationship of
1.2≧Ld/R(i−1)≧0.8,
where
Ld=[{Xc(i)−Xc(i−1)}²+{YC(i)−Yc(i −1)}²]^{1/2}.

That is, based on this conditional expression, it is determined whether or not the center of the after-determined circular orbit C(i) exists within a specified allowable range from the before-determined circular orbit is (i−1). In the present embodiment, the specified allowable range is exemplified as a range of no less than ±20% of the radius of the circular orbit C(i−1). But other appropriate ranges may be selected.

When the satisfaction of the second condition (i.e, the above two items) is confirmed by the second confirming block 44, the pattern determining block 45 then uses the central coordinates [Xc(i−1), Yc(i−1)] and [Xc(i), Yc(i)] to compute an angle θ on the basis of a formula of
tan θ=[Yc(i)−Yc(i−1)]/[Xc(i)−Xc(i−1)]
(step S39). The data of those central coordinates have been stored in the storage 43. As shown in FIG. 14, this angle θ expresses an angle made between a segment connecting the central points of those two circular orbits C(i−1) and C(i) and a reference line passing the central point of the circular orbit C(i−1) and being defined as θ=0 degree.

This pattern determining block 45 also uses the extreme-value information of the circular orbit C(i−1) stored in the storage 43 in order to determine the rotational direction of the circular orbit C(i−1), and then calculates control information from its rotational direction and the angle θ (step S40).

In this case, when the determined rotational direction of the circular orbit C(i−1) is counterclockwise, the pattern determining block 45 regards the counterclockwise rotational direction as selection of the sound volume control, which is one of the items being remote-operated. Thus, the block 45 decides a level of the sound volume depending on the absolute value of the angle θ (0≦θ<360 degrees), and notifies the control-signal outputting block 46 of the deiced sound volume level being desired (steps S40 and S41). In response to this notification, the block 46 outputs a gain control signal to the audio amplifier 12 depending on the notified sound volume level, whereby the audio amplifier 12 controls the sound volume at the specified level (step S42).

Meanwhile, when it is determined that the circular orbit C(i−1) rotates in the clockwise direction, the pattern determining block 45 regards the clockwise rotational direction as selection of the channels, which is also one of the items being remote-operated. Hence the block 45 decides a channel being selected, in combination with the rotational direction of the circular orbit C(i) and the angle θ. The decided channel information is given to the control-signal outputting block 46 (steps S40 and S42). Responsively to this notification, the block 46 outputs a channel selection signal to the tuner 5, so that a desired channel specified by the control signal is selected by the tuner 5 (step S42).

Concretely, as explained in FIG. 12, the pattern determining block 45 checks the rotational direction of the circular orbit C(i) (step S51). If this check reveals that the circular orbit C(i) rotates along the counterclockwise direction, a channel N being selected is decided as a positive integer that satisfies a conditional expression of
(θ/45)+(3/2)≧N>(θ/45)+(1/2)
(steps S52). In contrast, if the circular orbit C(i) rotates along the clockwise direction, a channel N being selected is decided as a positive integer that satisfies a conditional expression of
(θ/45)+(19/2)≧N>(θ/45)+(17/2)
(steps S53). Responsively to the resultant decision, the control-signal outputting block 46 provides a channel selection signal notifying the decided channel N to the tuner 5 (step S54).

Accordingly, for the counterclockwise rotation of the circular orbit C(i), a relation of “22.5 degrees>θ≧−22.5 degrees” enables the selection of channel “1,” a relation of “67.5 degrees>θ≧22.5 degrees” enables the selection of channel “2,” a relation of “112.5 degrees>θ≧67.5 degrees” enables the selection of channel “3,” . . . , a relation of “337.5 degrees>θ≧292.5 degrees” enables the selection of channel “8,” respectively. For the clockwise rotation of the circular orbit C(i), a relation of “22.5 degrees>θ−22.5 degrees” enables the selection of channel “9,” a relation of “67.5 degrees>θ≧22.5 degrees” enables the selection of channel “10,” a relation of “112.5 degrees>θ≧67.5 degrees” enables the selection of channel “11,” . . . , a relation of “337.5 degrees>θ≧292.5 degrees” enables the selection of channel “16,” respectively. For instance, as shown in FIG. 14, in a case where the circular orbit C(i) has a central point which is present in a range of “67.5 degrees>θ≧22.5 degrees” and rotates in the counterclockwise direction, the channel “2” can be selected. Meanwhile, when the circular orbit C(i) has the same central point as the above and rotates in the clockwise direction, the channel “10” can be selected.

In this way, in the present embodiment, the operator 50 who are in front of the CCD camera 1 rotate his or her hand in a circular orbit in the air. By this hand motion, the item being operated can be selected as either sound volume or channel selection and the amount being controlled of the selected item can be adjusted (controlled). As a generally used example in the present embodiment, the operator's hand motion includes two circular motions along circular orbits C(i−1) and C(i) to be determined in sequence, as mentioned above. The before-determined circular orbit C(i−1) has the two rotational directions (options), the angle θ obtained from the two circular orbits C(i−1) and C(i) is given eight angular ranges, and the after-determined circular orbit C(i) has the rotational directions (options). Thus, as a whole, it is possible to provide 32 selection patterns (2×8×2 patterns). These selection patterns can be applied to selecting an items being selected and controlling (adjusting) an amount of the selected item, as described in the present embodiment.

It is also possible that the selection patterns (i.e., operational information) coming from a combination of multiple hand circular-orbit motions are hierarchised into, for instance, to upper operation items and lower operation items. The hand rotational motions still provides a variety of items being selected for entering the operational information, providing a simple remote control to the TV receiver.

### Third Embodiment

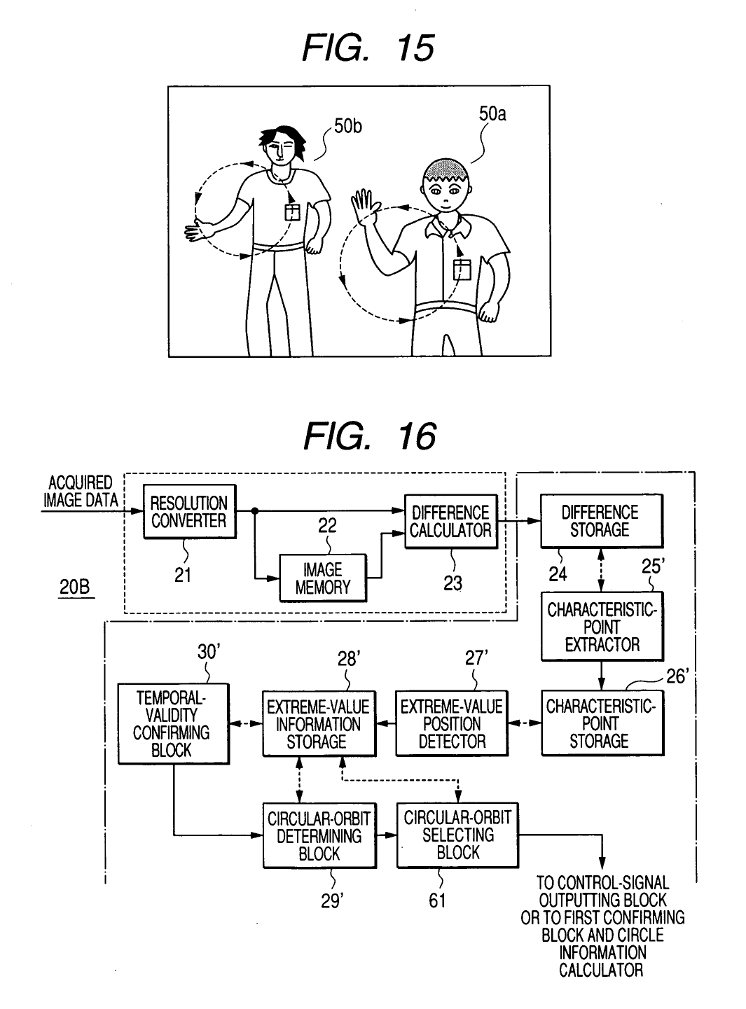

Referring to FIGS. 15-22, a third embodiment of the operational-information entering apparatus according to the present embodiment will now be described.

The operational-information entering apparatus of third embodiment relates to a scheme that allows plural operators (for example, two operators) moves their hands for entering operational information in front of the camera.

The foregoing first and second embodiments have been explained about the configuration where only one operator gives hand motions to the camera for the remote control. However, this is not always true, but plural persons can perform such remote control. In that case, it is necessary for the entering apparatus to receive motional information, person by person, without receiving simultaneously the motional information of the plural persons. In other words, it is required to select motions of either one or any one of the operators in preference to the other(s). For example, as shown in FIG. 15, when two operators 50a and 50b are moving their hands at the same time, some criteria are required to select the motions of only one operator for processing to be carried out thereafter.

An operational-information processor 20B according to the present embodiment is configured such that, of circular obits that expressed by plural operators' hands in the air, only a circular orbit having a maximum radius is selected and adopted as motional information intending to indicate a desired operation to the TV receiver.

This processor is partly shown in FIG. 16, where, as understood by comparison with FIG. 2, the processor 20B comprises the almost same members except that the members 25′ 26′, 27′, 28′ and 29′ ranging from a characteristic-point extractor 25′ to a circular-orbit determining block 29′ are able to process motional information from plural operators in parallel to each other and a circular-orbit selecting block 61 is inserted next to the circular-orbit determining block 29′. Though not shown in detail, the outputted information from this selecting block 61 is sent to either the control-signal outputting block 45 (refer to FIG. 2) is in the case of the control in the first embodiment or the circular-orbit selecting block 61 and circle information calculator 42 (refer to FIG. 10) in the case of the control in the second embodiment.

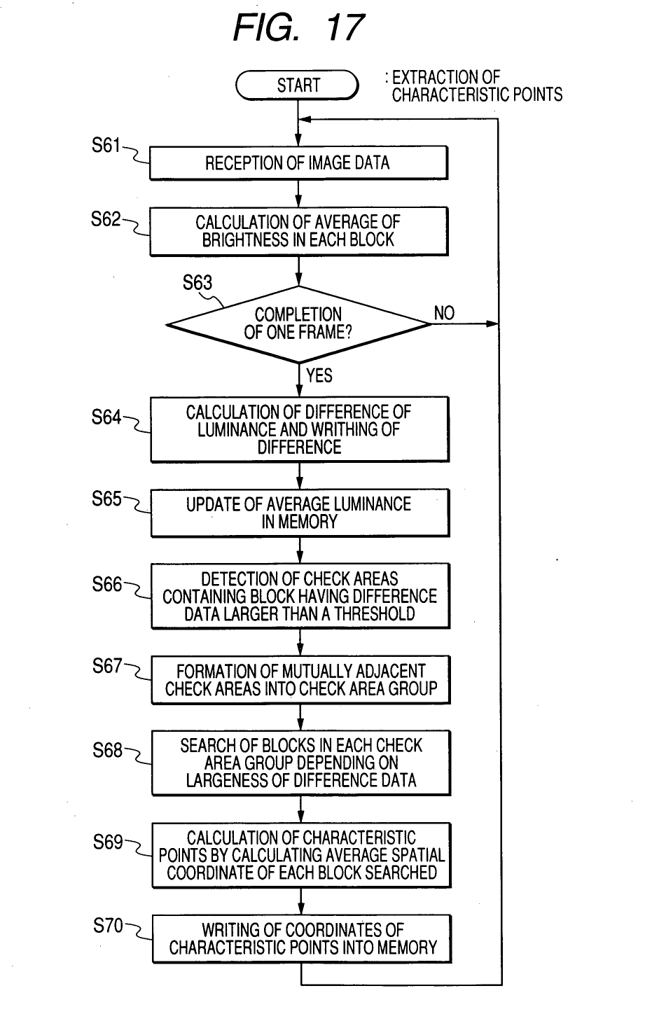

In FIG. 16, the resolution converter 21, image memory (frame 22, difference calculator 23, and difference storage 24 are identical to those explained already in the first embodiment, so that the processing at steps S61-S65 in FIG. 17 are the same as steps S1-S5 in FIG. 3.

The processing for extracting characteristic points, which is carried out by the characteristic-point extractor 25′, is shown in FIG. 17.

In the present embodiment, step S65 is followed by step S66 and S67. That is, each frame of image data is divided into plural areas of “4×4 blocks” (i.e., 32×32 pixels), so that each block provides a rectangular area being checked. And, of the difference-data blocks stored in the difference storage 24, check areas containing blocks whose difference data is equal to or higher than a predetermined threshold are detected (step S65). Then, of the check areas, mutually juxtaposed areas are made to compose check area groups (step S67). The threshold for detecting the areas is set to a lower limit of the difference data yielding when. the motions of operators' hands are extracted. Each block, which is 16 times larger than each area, is thus used to trace the motions of the hands.

The use of the larger inspected as a minimum area unit and the use of the check area group imaging hand motions through the areas is for the purpose of distinctively separating the hand motions of one operator from those of another operator.

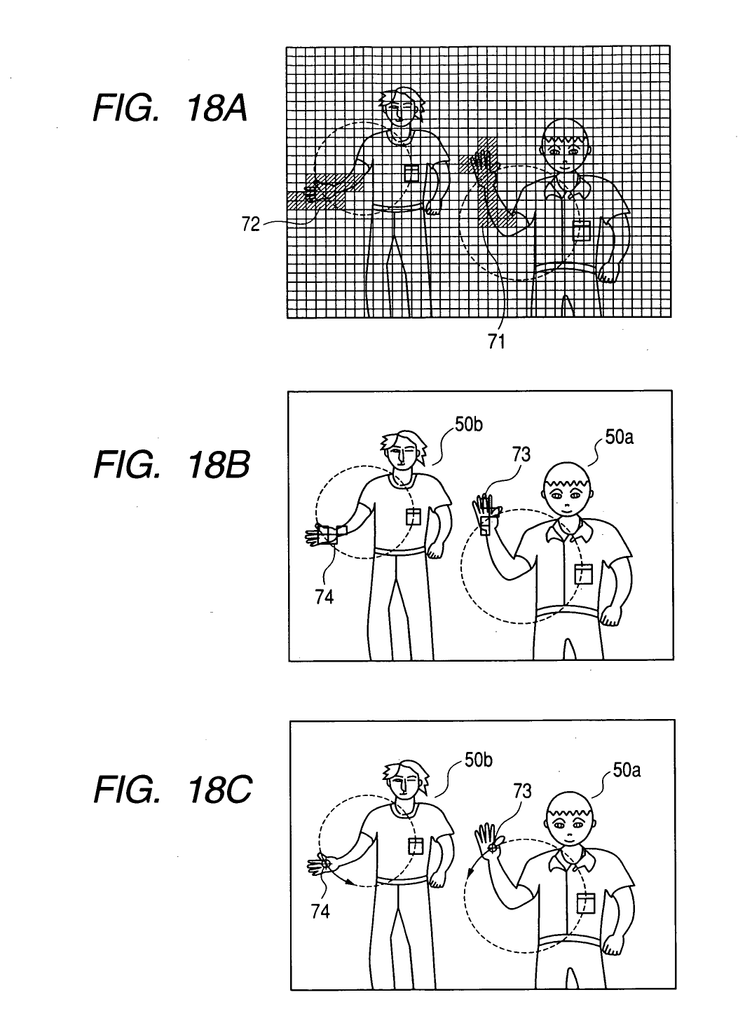

For example, as shown in FIG. 15, assume that two operators 50a and 50b are individually moving their hands to trace circular orbits in the air. In such a situation, two shaded portions in FIG. 18A are check area groups 71 and 72 in which the two operator's hand motions are reflected. In this example, both check area groups 71 and 72 are positioned apart from each other by 5 check areas or more. However, if obeying the way using the check area groups, it is said that the two check area groups 71 and 72 are composed to mutually be separated by one check area or more.

On completion of the check area group, of the difference data of the respective blocks contained in the check area group, search is made for all the blocks to find the first to fourth largest blocks in their areas (step S68). And the spatial coordinates of each of the searched blocks are averaged as characteristic points (step S69). That is, blocks representing noticeable motions are found in the area occupied by each check area group and the center of each motion is decided as being a characteristic point. Thus, in cases where there are plural check area groups (i.e., there are plural operators who move their hands), the characteristic points can be obtained every check area group. For example, there are formed plural check area groups 71 and 72 as shown in FIG. 18A, a block group 73 (74) is found every check area group 71 (72) as shown in FIG. 18B, and then a characteristic point 75 (76) is found every block group 73 (74) as shown in FIG. 18C.

The coordinates of the decided characteristic points, as above, are stored in sequence into the storage 26′ with those data updated on a ring buffer basis. One feature is that this storage 26′ is provided with a plurality of sectioned memory regions, in which the characteristic points from the plural information flow paths, i.e., plural block groups respectively assigned to the plural operators, are written into the different memory regions, respectively (step S70).

Incidentally, similarly to the first embodiment, it is assumed that, under the condition that each operator rotates his or her hand two rotations per 2 seconds, the expression of each of the X- and Y-coordinates occupy 1 byte and there are prepared five memory regions in the storage 26′. In this case, it is sufficient that the characteristic-point storage 26′ has a memory capacity of 600 bytes (=2 bytes×30 frames×2 seconds×5 memory regions) at the lowest.

The processes at steps S61 to S69 are repeated every time when each frame of image data is acquired from the CCD camera 1 (steps S70 to S61). As a result, during a period of time in which the operators move their hands, the special coordinates of the characteristic points expressing the contour of each hand are consecutively saved, operator by operator, into the storage 26′ for the newest 2 seconds. By way of example, in the example shown in FIG. 18C, the spatial coordinates of each characteristic point 75 (76) resulting from the hand motion of each operator 50a (50b) are written into the respective memory regions as mutually separated information.

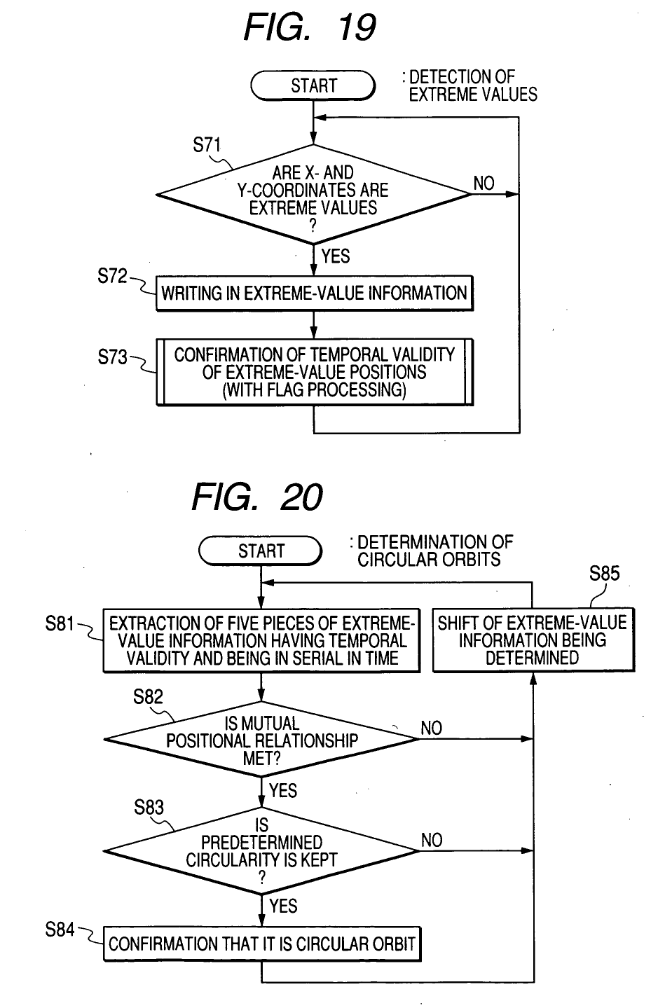

Then the processing is shifted to the processes shown in FIG. 19, where the data of the characteristic points stored in the storage 26′ are subjected to the same processing as that in the first embodiment, every block group. That is, every block group, the characteristic points are subjected to the detection of extreme points at the extreme-value position detector 27′ (step S71), writing extreme-value information (the spatial coordinates of the extreme-value positions. and the detection time instants) into the storage 28′ (step S72), and confirming that the extreme-value positions are temporally valid, which is carried as flag processing at the temporal-validity confirming block 30′ (step S73). The extreme-value information storage 28′ is also provided with plural sectioned memory regions into which the information of the extreme-value points are stored every information flow path, that is, every check area group corresponding to each operator.

The extreme-value information (including flag information showing the temporal validity of the data) stored in the storage 28′ then undergoes the determination performed by the circular-orbit determining block 29′. This processing is shown as a flowchart in FIG. 20 (steps S81-S85), which is also basically similar to that in the first embodiment (refer to steps S21-S24, S28 in FIG. 5). However, the processes corresponding to steps S25-S27 in FIG. 5 are omitted in FIG. 20. Those processes are replaced by later-described selection of a circular orbit in the present embodiment. In addition, FIG. 20 has a difference in that the present embodiment takes into account that the extreme-value Information is acquired every information flow path, that is, every check area group.

Thus, the determination for the authenticity of a circular orbit is also performed, every check area group, with the extreme-value information stored in each memory region of the storage 28′.

Accordingly, as shown in FIG. 18C, when the two operators 50a and 50b move their hands along circular orbits at the same time, the circular-orbit determining block 29′ results in two affirmative determinations. However, to receive the two circular-orbit motions as operational information is impossible, so that it is required to select either one from the two motions.

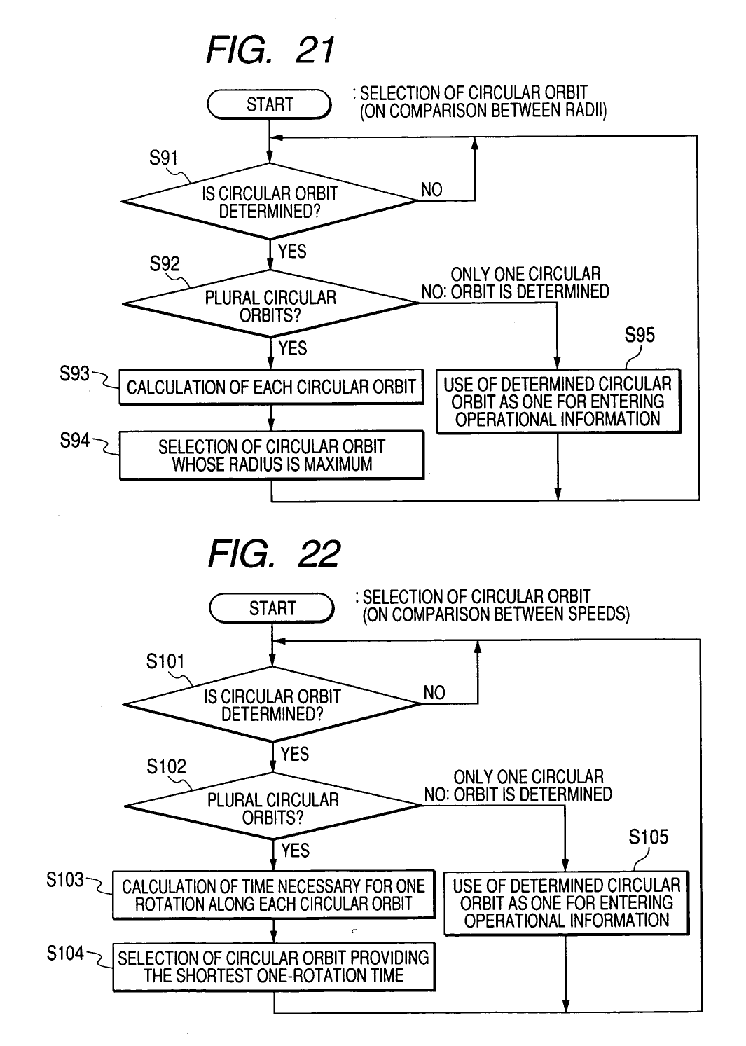

In order to cope with such selection, the processor 20B is provided with the circular-orbit selecting block 61, which performs the processing shown In FIG. 21. First, when plural circular orbits are determined during one frame period (steps S91 and S92), the block 61 calculates the diameter of each circular orbit (step S93). The radius can be calculated using the extreme-value positions of which information is written in the storage 28′. Practically, using the spatial coordinates at the right and left, or upper and lower extreme-value positions of the coordinates corresponding to each circular orbit (refer to FIG. 6), a distance (diameter) between the extreme-value position in the horizontal or vertical direction. The radius can be figured out as half the distance.

The resultant radii of the respective circular orbits are then subjected to mutual length comparison, which allows only one circular orbit exhibiting the largest radius to be selected as an objective circular orbit (step S94).

The reason why the radius length is a criterion for the selection is based on the strong and reliable assumption that the larger the radius of the circular orbit, the closer the operator the receiver (i.e., the CCD camera). And it can be assumed that this closer positioning is a kind of expression of a strong will for operating the receiver. For example, in the case of FIG. 18C, the circular orbit depicted by the operator 50a is larger than that by the other operator 50b. As a result, the circular orbit made by the operator 50a is selected as operation information to be entered into the receiver.

Incidentally, when only one circular orbit is made by for example one operator in the present TV receiver, this TV receiver accepts the one circular orbit as operational information.

In the present embodiment, the radius of the circular orbit has been the criterion for the selection, but another one can be adopted for the criterion. For example, another possible criterion is a period of time necessary for one-time rotation of a circular orbit. The processing on this criterion is shown in FIG. 22. The circular-orbit selecting block 61 works such that if there are determined a plurality of circular orbits within one frame period (steps S101 and S102), the period of time necessary for one-time rotation of each circular orbit is computed (step S103). And only the circular orbit showing the shortest period of time is selected as operational information being entered Into the TV receiver (step S104). The computation of such period of time is based on the information about the detection time instants stored in the storage 28′. It is assumed that if an operator really wishes to operate the receiver, such a wish will be reflected in the speed of hand motions. That is why the period of time is adopted as the criterion for the selection. Meanwhile, if only one circular orbit is detected during the period of time of one frame, the one circular orbit is adopted as operational information.

Hence, in cases where a plurality of operators moves their hands in front of the CCD camera 8 of the TV receiver, the operational-information processor 20B can select operational information based on an appropriately selected motion, with avoiding confusion due to the plural motions, thus providing a reliable information entering scheme to the TV receiver.

As stated, in the foregoing various embodiments, remote control devices such as a remote control are no longer necessary. Operator's hand motions are recognized to be inputted to the receiver as desired operational information. That is, circular-orbit motions of an operator's hand, which is a typical hand action to express the will for operations, are determined with reliability. Thus, the operational information can be inputted to the receiver in a reliable manner. Further, the combinations of the rotational directions of hand circular-orbit motion with the positional relationship between successive hand circular orbit motions enable various pieces of operational information to be combined into a hierarchical structure, thus giving a reasonable and simpler expression to a variety of types of operational information.

By the way, the foregoing various embodiments have focused on one or more operator's hand which is moved in the air, but this is not a definitive list. The present invention may be reduced into practice in the same way as the above by imaging other parts of the human, such as the head or the foot.

The present invention may be embodied in several other forms without departing from the spirit thereof. The present embodiments as described are therefore intended to be only illustrative and not restrictive, since the scope of the invention Is defined by the appended claims rather than by the description preceding them. All changes that fall within the metes and bounds of the claims, or equivalents of such metes and bounds, are therefore intended to be embraced by the claims.

What is claimed is:

1. An apparatus for entering operational information to an objective device based on a motion of an operator's hand;
an imaging device acquiring image data of the operator's hand;
an extracting unit extracting characteristic points of the motion of the hand in a spatial coordinate system of the image data by applying processing to the image data;
a detecting unit detecting, as extreme-value information, extreme-value points appearing in spatial coordinates of the characteristic points and detection time instants at which the extreme-value points appear;
a memory device in which the extreme-value information is memorized;
an orbit determining unit determining whether or not four or more consecutive pieces of the extreme-value information corresponding to desired operational information comply with a predetermined circular-orbit condition; and
an outputting unit outputting the desired operational information to the device depending on a result determined by the orbit determining unit.

2. The apparatus of claim 1, wherein
the outputting unit is configured to output to the objective device the desired operational information, when the determining device determines that the four or more consecutive pieces of the extreme-value information comply with the circular orbit pattern.

3. The apparatus of claim 2, wherein the extracting unit comprises means for applying, as the processing, processing to detect a movement of the hand to images produced by the image data, each image being divided into a plurality of blocks and the processing to detect the movement being applied block by block.

4. The apparatus of claim 1, wherein
the extracting unit is configured to extract the characteristic points of the motion of the hand from the image data acquired from a plurality of operators, operator by operator;
the detecting unit is configured to detect the extreme-value information, operator by operator;
the memory is configured to memorize the extreme-value information, operator by operator;
the determining unit is configured to performing the determination, operator by operator; and
the outputting unit comprises means for determining whether or not the determining unit performs the compliance with each of the plurality of operators; means for making a comparison between attributes of a plurality of circular orbits based on the four or more consecutive pieces of the extreme-value information concerning the plurality of operators, when the compliance is determined as to each of the plurality of operators; means for selecting one circular orbit from the plurality of circular orbit; and means for outputting to the device the desired information corresponding to the circular orbit selected.

5. The apparatus of claim 4, wherein
the attribute is either the radius of each of the plurality of circular orbits or a speed at which each of the plurality of circular orbits is depicted, and
the selecting means is configured to select a circular orbit whose radius is a maximum when the attribute is the radius and to select a circular orbit of which depicting speed is a maximum when the attribute is the speed.

6. The apparatus of claim 1, wherein
the predetermined circular orbit-condition consists of a condition regulating a relative positional relationship of the spatial coordinates of the extreme-value condition whose detection time instants are sequential in time and a condition regulating a predetermined circularity that should be satisfied by a circular orbit estimated from the spatial coordinates included in the extreme-value information whose detection time instants acquired along one rotation of the circular orbit are sequential in time

7. The apparatus of claim 1, further comprising
a temporal-validity determining device determining whether or not a circular orbit estimated from the extreme-value information stored in the memory is temporally valid, only the extreme-value information determined to be temporally valid being provided to the orbit determining unit.

8. The apparatus of claim 7, wherein the temporal-validity determining device is configured to perform the determination based on a temporal condition consisting of a first time difference between a first detection time instant and a last detection time instant both included in the extreme-value information of which detection time instants along one circular orbit are sequential in time, the one circular orbit being estimated from the spatial coordinates included in the extreme-value information whose detection time instants are acquired during one turn of the circular orbit, and a second time difference between mutually adjacent detection time instants included in the extreme-value information of which detection time instants are sequential in time.

9. The apparatus of claim 1, further comprising an association determining unit determining whether or not it is possible to mutually associate a plurality of circular orbits estimated in sequence from the extreme-value information that has been determined to comply with the predetermined circular-orbit condition by the orbit determining unit,
wherein the outputting unit is configured to output to the device the desired operational information with a plurality of items being operated based on the plurality of circular orbits when the association determining unit determines the association.

10. The apparatus of claim 9, wherein
the association determining unit comprises means for determining whether or not a time difference between the plurality of circular orbits is within a predetermined range; means for calculating a central coordinate and a size of each of the plurality of circular orbits when it is determined that the time difference is within the predetermined range; and means for calculating a relative positional relationship between the plurality of circular orbits on the basis of the central coordinates and the sizes, and
the outputting unit is configured to output to the device the desired operational information with the plurality of items based on the relative positional relationship between the plurality of circular orbits.

11. The apparatus of claim 10, wherein
the association determining unit further comprises means for calculating a rotational direction of each of the plurality of circular orbits and
the outputting unit is configured to output to the device the desired operational information with the plurality of items based on the rotational direction as well as the relative positional relationship between the plurality of circular orbits.

12. An apparatus for entering operational information to an objective device based on a motion of an operator's hand, comprising:
imaging means for acquiring image data of the operator's hand;
extracting means for extracting characteristic points of the motion of the hand in a spatial coordinate system of the image data by applying processing to the image data;
detecting means for detecting, as extreme-value information, extreme-value points appearing in spatial coordinates of the characteristic points and detection time instants at which the extreme-value points appear;
orbit determining means for determining whether or not four or more consecutive pieces of the extreme-value information corresponding to desired operational information comply with a predetermined circular-orbit condition; and
outputting means for outputting the desired operational information to the device depending on a result determined by the orbit determining means.

13. A method of entering operational information to an objective device based on a motion of an operator's hand, comprising steps of:
acquiring image data of the operator's hand;
extracting characteristic points of the motion of the hand in a spatial coordinate system of the image data by applying processing to the image data;
detecting, as extreme-value information, extreme-value points appearing in spatial coordinates of the characteristic points and detection time instants at which the extreme-value points appear;
determining whether or not four or more consecutive pieces of the extreme-value information corresponding to desired operational information comply with a predetermined circular-orbit condition; and
outputting the desired operational information to the device depending on a result determined by the orbit determining step.
